(19) United States
(12) Patent Application Publication
(10) Pub. No.: US 2025/0384724 A1
(43) Pub. Date: Dec. 18, 2025

(54) Driving a Motor Vehicle by Utilizing a Mobile Device

(71) Applicant: Bayerische Motoren Werke Aktiengesellschaft, Muenchen (DE)

(72) Inventors: Thorsten KNOTT, Tuntenhausen (DE); Khaled Kombas, Muenchen (DE)

(21) Appl. No.: 19/211,439

(22) Filed: May 19, 2025

(30) Foreign Application Priority Data
Jun. 17, 2024 (DE) 10 2024 117 005.0

(51) Int. Cl. G07C 9/00

(52) U.S. Cl. CPC G07C 9/00309; G07C 2009/00325; G07C 2009/00769

(57) ABSTRACT

A method for controlling a motor vehicle by utilizing a mobile device includes detecting that a touch-sensitive screen of the mobile device has been disabled due to a low charge status of an energy storage device, detecting an operation of a physical switch of the mobile device, establishing a Bluetooth connection with the motor vehicle and transmitting a request to unlock the motor vehicle via the Bluetooth connection.

### CROSS REFERENCE TO RELATED APPLICATION

This application claims priority under 35 U.S.C. § 119 from German Patent Application No. 10 2024 117 005.0, filed Jun. 17, 2024, the entire disclosure of which is herein expressly incorporated by reference.

### BACKGROUND AND SUMMARY

The present invention relates to controlling a motor vehicle by utilizing a mobile device. In particular, the invention relates to controlling the vehicle when an electrical energy storage function on the mobile device is exhausted.

A motor vehicle is to be set up for controlling by utilizing a digital vehicle key. The digital vehicle key can be implemented in accordance with the proposals of the Car Connectivity Consortium, which are published in the technical specification “Digital Key Release 3”. The digital vehicle key initially establishes a Bluetooth connection between the mobile device and the vehicle. When the mobile device is moved closer to the motor vehicle, then an ultra-wideband (UWB) connection can be established, via which a distance between the mobile device and the motor vehicle can be precisely determined and which can be used to implement the authentication process. Authentication will be preferably based on an asymmetric cryptographic procedure.

If a mobile device's energy storage is exhausted, then all the interfaces of the mobile device are usually switched off whenever possible. These include a touch-sensitive screen and a Bluetooth interface. Access to the vehicle can still be controlled by the mobile device when it continues to operate an NFC interface. The range of this interface is however short, so a transceiver must always be provided in proximity to the outer layer of the vehicle to unlock the vehicle. An additional transceiver can be fitted in the interior to enable a drive motor to be started. However, this approach does not permit a user of the mobile device to control the function of the motor vehicle itself, to select an option and/or to be informed about an upcoming control process. Deploying multiple NFC transceivers can be complex and costly when implemented on the vehicle side.

An underlying task of the present invention is to provide an improved technology for controlling a motor vehicle by utilizing a mobile device whose energy storage has a very low charging status. The invention solves this problem by utilizing the objects of the independent claims. Subclaims indicate preferred embodiments.

According to a first aspect of the present invention, a method of controlling a motor vehicle by utilizing a mobile device comprises the steps of detecting that a touch-sensitive screen located on the mobile device is disabled due to a low charging status of an energy storage device, detecting operation of a physical switch located on the mobile device. Establishing a Bluetooth connection with the motor vehicle and transmitting a request to unlock the motor vehicle via the Bluetooth connection.

According to the invention, the user of the mobile device can control whether to unlock the motor vehicle. The vehicle can be unlocked without requiring a connection other than the installed Bluetooth function. An NFC transceiver can be dispensed with on the part of the motor vehicle. The mobile device can also be utilized without an NFC interface.

The mobile device can include one or more physical switches that are eligible for actuation. Such a switch is usually available for basic operations such as switching the mobile device on or off. Accordingly, the actuation of the switch can still be detected even when the energy storage device charge status is very low. The switch can, for example, comprise a two-, three- or multiple-step switch. A push-button switch can also be provided, which is often used to set the volume. Furthermore, a hardware switch can be provided whereby the function of which can be defined by a user. In contrast to a virtual switch, which can be displayed on the touch-sensitive screen, the physical switch therefore retains its function even when all output devices are deactivated for a user. The user can inspect the operation of the switch haptically.

In an additional embodiment, the physical switch is implemented by a device which is deemed to be independent of the rest of the mobile device and performs the function of a switch. For example, a capacitive sensor or a pressure-sensitive sensor can be provided which, when actuated by a user, thereby provides a signal to the mobile device which corresponds to that of a switch. The decisive factor in this case is that the device does not require any output to the user for its function to operate, as is the case with a touchscreen, for example.

A predetermined sequence of actuation of the switch is also preferably detected. In this way, accidental actuation or accidental activation of the Bluetooth connection or accidentally unlocking the vehicle can be prevented. For example, it is possible to detect that the switch has been actuated several times in a predetermined manner. For example, a double click, triple clicks or a multiple click can be generally detected. It is also possible to detect that the switch has been actuated for a predetermined minimum duration. Different actuation durations or different pause durations between two actuations can be detected. A predetermined sequence of short and/or long actuations and pauses can therefore be defined to trigger the described function.

In an additional preferred embodiment, the mobile device comprises a plurality of physical switches, whereby a predetermined sequence of actuations of the plurality of switches is detected. For example, the function can be controlled when a two-step switch is located in a predetermined position and another switch is actuated in a predetermined manner. The two-stage switch can therefore be provided to control a do-not-disturb function.

The request transmitted from the mobile device to the motor vehicle can include authentication information and/or an indication of the low charge level of the energy storage device. The authentication information can include a predetermined secret code or be based on a cryptographic procedure. It is also preferred that the Bluetooth connection is utilized to determine that the mobile device is not located further away from the motor vehicle than a predetermined distance. For this purpose, the signal strength of the Bluetooth connection can be determined and evaluated by the motor vehicle or the mobile device. The signal strength can, for example, be provided by the Bluetooth interface as a signal (Received Signal Strength Indicator, RSSI). Alternatively, the distance can also be determined by using channel sounding.

This function is part of the current Bluetooth standard and is based on the determination of a signal propagation time between the stations. The distance can be determined on one or both sides and a determination result can be transmitted to the other side.

In an additionally preferred embodiment, an actuation of a predetermined control element which is accessible on the outside of the motor vehicle can be detected. Such a control element can, for example, comprise a push button located on a door handle. The vehicle-side control element can only be actuated after the request from the mobile device has been received and the optional authentication and/or distance determination has been successfully concluded. This enables the user to control the function of the vehicle themselves without having to interact with the mobile device. The control element installed on the motor vehicle can be simple and inexpensive. Such a control element can already be provided on many motor vehicles for other reasons.

If all the predetermined conditions are fulfilled, then the motor vehicle can be unlocked in response to the request. A user of the mobile device can thereby gain access to the interior of the motor vehicle. They can charge their mobile device from an on-board power supply of the motor vehicle, which is located inside, so that the usual functions for controlling the motor vehicle by utilizing the mobile device can be available again after a short time. In particular, an additional function of the motor vehicle can be controlled conventionally by using the mobile device. This additional function can include deactivating an immobilizer and/or starting a drive engine.

However, in a continuation of the method described, it is not necessary to charge the energy storage of the mobile device before the motor vehicle can be subsequently moved. It is further proposed that an actuation of a predetermined control element located in the interior of the motor vehicle is detected, that a request for authentication is transmitted to the mobile device via the Bluetooth connection and that the mobile device initiates authentication with the motor vehicle.

Advantageously, the already established Bluetooth connection can be utilized to detect a user's request to perform authentication. It is difficult for the user to enter this request directly on the mobile device while the touch screen has been deactivated.

Authentication can be a prerequisite for driving the motor vehicle. Preferably, authentication comprises the implementation of a predetermined procedure, which can be particularly based on an asymmetric cryptographic key system.

Authentication can be based on an ultra-wideband connection. This technology can advantageously be used to simultaneously determine the distance of the mobile device from the motor vehicle. Preferably, a position of the mobile device as relative to the motor vehicle is to be determined and authentication will only take place when the position is located within a predetermined range relative to the motor vehicle.

It is also preferred that authentication is to be based on a digital vehicle key which is stored on the mobile device. The digital vehicle key can be stored in a secure memory (Trusted Platform Module, TPM). The digital vehicle key can be utilized to secure the vehicle in accordance with the specifications of the Car Connectivity Consortium. A security function such as the release of an immobilizer can therefore be secured using the aforementioned technology, so that the security function can only be controlled after a valid digital vehicle key has been presented.

According to an additional aspect of the present invention, a control device for a motor vehicle comprises a Bluetooth interface and a processing device. The processing device is arranged to establish a Bluetooth connection to a mobile device, to receive a request to unlock the motor vehicle via the Bluetooth connection, to detect an actuation of a control element which is accessible on an exterior of the motor vehicle and to unlock the motor vehicle.

Unlocking can comprise a door or a boot located on the motor vehicle. In one embodiment, several doors and/or boots can be unlocked by utilizing a central locking system or, optionally, one door or boot can also be opened. The operating element can comprise a button or switch, for example. In an additional embodiment, contactless actuation of the control element can also be possible. For this purpose, the operating element can comprise a gesture control or a capacitive proximity switch, for example.

According to yet another aspect of the present invention, a motor vehicle comprises a control device as described herein. Preferably, the motor vehicle comprises a passenger car. Typically, the motor vehicle is fitted with an interior which is accessible only after the motor vehicle or a door, boot or tailgate has been unlocked. In other embodiments, the motor vehicle can also comprise, for example, a truck or a bus.

According to yet another aspect of the present invention, the mobile device comprises a touch-sensitive screen, a physical switch, an electrical energy storage device, a Bluetooth interface and a processing device. In this case, the processing device will be adapted to detect that the touch-sensitive screen has been deactivated due to a low charge status of the energy storage device, to detect an actuation of the physical switch, to establish a Bluetooth connection with the motor vehicle and to transmit a request to unlock the motor vehicle via the Bluetooth connection.

The mobile device can comprise a smartphone. Alternatively, the mobile device can comprise a similar or equivalent device, such as a smart watch, a smart armband or a smart ring. A body-worn mobile device (wearable) is also possible. In yet another embodiment, the mobile device can comprise a head-mounted device which can be attached to a user's head.

A method described herein can therefore be executed by utilizing a system described here, which comprises a mobile device and a motor vehicle or a control device. Some parts of the method can be implemented by the mobile device and other parts by the motor vehicle or from the control device. For this purpose, the mobile device or the control device can comprise a processing device, which preferably comprises an integrated circuit, a programmable logic device or a programmable microcomputer. The method can be implemented in the form of a configuration or as a computer program product equipped with program code means for the processing device. The configuration or computer program product can be stored on a computer readable medium. Features or advantages of the method can be transferred to one of the devices or the system or vice versa.

The invention will now be described in more detail with reference to the accompanying drawings, in which:

### BRIEF DESCRIPTION OF THE DRAWINGS

FIG. 1 illustrates a system with a motor vehicle and a mobile device,

FIG. 2 illustrates a flow chart of a process, and

FIG. 3 illustrates a schematic representation of a mobile device.

### DETAILED DESCRIPTION OF THE DRAWINGS

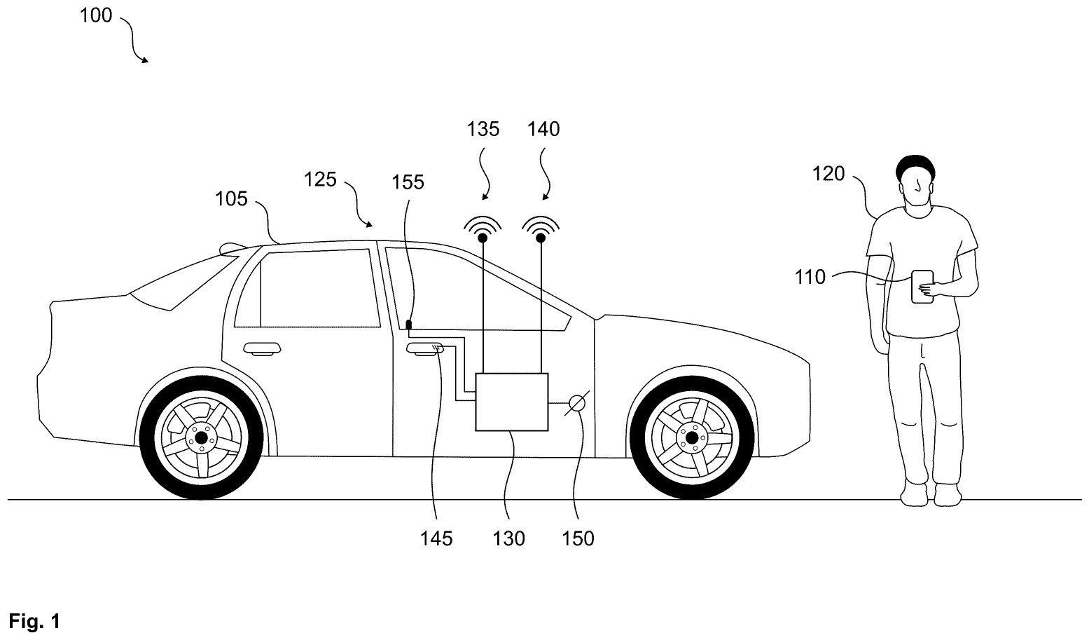

FIG. 1 illustrates a system 100 with a motor vehicle 105 and a mobile device 110. The mobile device 110 is assigned to a user 120. To explain the present invention, it is assumed that the user 120 is located outside the motor vehicle 105 with the mobile device 110 and that the motor vehicle 105 is locked.

On board the motor vehicle 105, a control device 125 comprising a processing device 130, a Bluetooth interface 135 and a UWB interface 140 have been installed. A control element 145, which is accessible from outside the motor vehicle 105, can also be connected to the processing device 130. Also preferably, an interface 150 is to be provided via which a safety function of the motor vehicle 105 can be controlled. The security function can include locking or unlocking a vehicle door, tailgate or vehicle boot of the motor vehicle 105 or activating or deactivating an immobilizer. A control element 155 can be provided in an interior, which can only be operated by a person who already has access to the interior.

The mobile device 110 and the control device 125 are preferably set up to secure the motor vehicle 105 according to the specifications of the digital car key. For this purpose, a digital car key can be stored on the mobile device 110. In a usual operation, the user 120 can operate the mobile device 110 to initiate an authentication for the mobile device 110 with the control device 125. Typically, the user 120 must authenticate themself to the mobile device 110 for this purpose. This can be implemented by presenting a biometric feature or by entering a predetermined secret code. Interaction with the mobile device 110 usually requires the use of a touch-sensitive screen and optionally other peripheral devices of the mobile device 110.

The technology described assumes that the mobile device 110 can only be utilized in a rudimentary manner by the user 120 and thereby proposes a method in which the motor vehicle 105 can nevertheless be controlled in a user-friendly manner and with little technical effort.

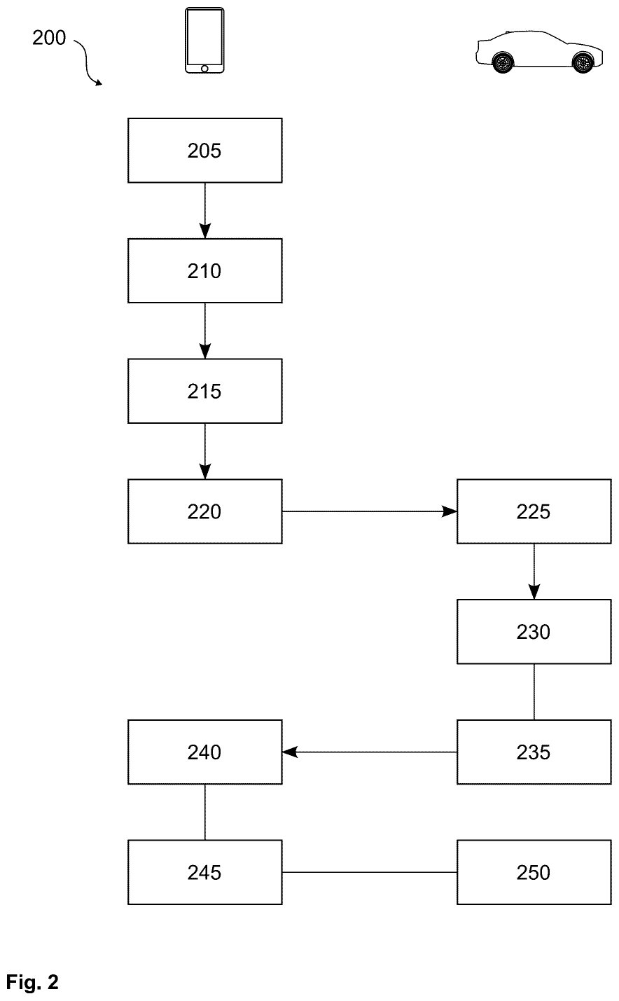

FIG. 2 illustrates a flowchart of an exemplary method 200 for controlling the motor vehicle 105 by utilizing the mobile device 110. Steps which are more attributable to the mobile device 110 are represented in a left-hand area in FIG. 2, while other steps which are more attributable to the motor vehicle 105 are represented in a right-hand area. The placement is merely for the sake of clarity.

In Step 205, the mobile device 110 is positioned in an energy-saving mode. The energy-saving mode can be activated when a charging status of an energy storage device of the mobile device 110 falls below a predetermined threshold value. In this case, one or more peripheral devices of the mobile device 110 can be deactivated. These include a touch-sensitive screen, a wireless interface for a mobile network, various sensors or a vibration motor located on the mobile device 110. Deactivation can disrupt a usual interaction between the user 120 and the mobile device 110.

In Step 210, the actuation of a physical control or input element of the mobile device 110 can be detected. This input element can comprise a switch or, even more preferably, a tactile switch. For example, the user 120 can actuate a tactile switch which can be utilized to turn the mobile device 110 on or off. Furthermore, it can be determined that, for example, a touch switch for raising or lowering the playback volume has been actuated.

In combination with the energy-saving mode, the detected actuation can result in a Bluetooth interface located on the mobile device 110 being activated in Step 215 and a Bluetooth connection to the motor vehicle 105 or to its control device 125 being established. For this purpose, the motor vehicle 105 can notify the communication service, which is provided, and the mobile device 110 can therefore recognize the communication service and establish the connection to it. In one embodiment, the mobile device 110 thereby stores the Bluetooth service which is required for communication with the motor vehicle 105 and a connection is established exclusively with this service.

In Step 220, a request can be transmitted to the motor vehicle 105 via the established Bluetooth connection. In particular, the request can relate to unlocking a door or boot of the motor vehicle 105. In addition, and preferably, the request comprises an indication that the energy storage of the mobile device 110 is very low or almost completely depleted. The request can be accompanied by additional information, for example, with information included for authenticating the mobile device 110 to the motor vehicle 105. In an additional embodiment, a distance and/or direction determination can be executed based on the Bluetooth connection. In this way, a relative position of the mobile device 110 with respect to the motor vehicle 105 can be at least roughly determined. Corresponding measurement or determination values can be exchanged via the Bluetooth connection.

In Step 225, the motor vehicle 105 can determine that the predetermined control element 145, which is accessible on the exterior of the motor vehicle 105, has been actuated.

In Step 230, it can be reviewed whether all the prerequisites for unlocking the motor vehicle 105 have been fulfilled when the energy storage of the mobile device 110 is exhausted. If this is the case, then a door, tailgate or boot of the motor vehicle 105 can be unlocked. The user 120 can open the door, tailgate or boot and enter the motor vehicle 105, where they therefore have access to the additional operating element 155.

In Step 235, the actuation of the control element 155 located in the interior of the motor vehicle 105 can be detected. The control element 155 can, for example, relate to a start-stop switch for a drive engine of the motor vehicle 105. Other control elements 155 which are located in the interior can also be used, for example, a gear or transmission selector lever or a light switch.

In response to the detected actuation of the control element 155 positioned in the previously requested energy-saving mode by the mobile device 110, the control device 125 can transmit a request or an indication of the actuation to the mobile device 110. On the part of the mobile device 110, an actuation of the switch 315 of the mobile device 110 can be detected in Step 235. This actuation can be understood to be a confirmation by the user. In another embodiment, Step 235 can be omitted, and the user 120 can proactively actuate the switch 315 of the mobile device 110 in Step 240.

In Step 245, the mobile device 110 can establish a UWB connection with the motor vehicle 105, authentication can therefore be performed via the UWB connection based on the digital vehicle key which has been stored on the mobile device 110. For this purpose, a relative position of the mobile device 110 with respect to the motor vehicle 105 can be determined on the basis of the UWB connection.

If the authentication was successful and it could be determined that the mobile device 110 is located within a predetermined range with respect to the motor vehicle 105, then the motor vehicle 105 will thereby release an immobilizer located on the motor vehicle 105 or start a drive motor in Step 250. Alternatively, another safety function which enables the motor vehicle 105 to move or drive can be controlled.

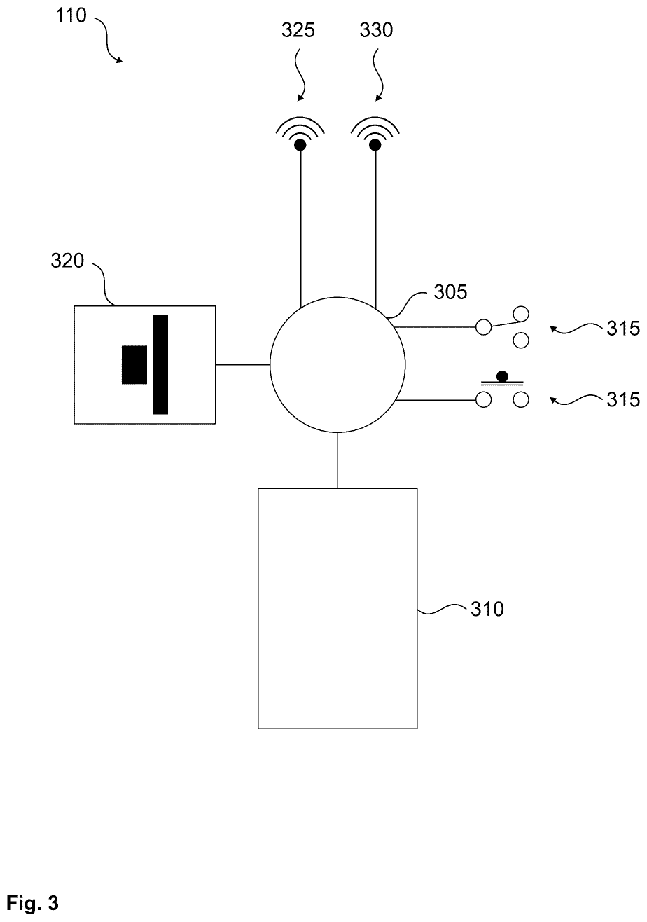

FIG. 3 illustrates a schematic representation of a mobile device 110 of the system 100 of FIG. 1. The mobile device 110 comprises a processing device 305, a touch sensitive screen 310, a minimum of one physical switch 315, an electrical energy storage 320 and a Bluetooth interface 325. In addition, and preferably, a UWB interface 330 is also provided.

It should be noted that the mobile device 110 can also include other elements which are not represented here. In particular, additional peripheral devices can be provided, for example, a position sensor or acceleration sensor, a vibration motor, a microphone, a loudspeaker or a magnetic field sensor. In addition, the mobile device 110 can also be equipped with an NFC interface.

The processing device 305 is set up to deactivate as many peripheral devices as physically possible when a charge status of the electrical energy storage device 320 drops below a predetermined threshold value. The processing device 305 is then also preferably operated in an energy-saving mode, in which it operates only slowly, with few resources or intermittently.

FIG. 3 illustrates an example of an initial switch 315, which is equipped with two stable mechanical positions. Such a switch 315, for example, enables a do-not-disturb or silent function for the mobile device 110 to be activated or deactivated.

A second exemplary switch 315 is designed as a push-button switch. The momentary-action switch 315 is monostable, i.e., it can therefore be actuated and always returns to a predetermined rest position after the end of actuation.

A switch 315 can be utilized to turn the mobile device 110 on or off. An actuation status for switch 315 can be monitored by the processing device 305 directly or by utilizing a suitable peripheral module, the function of which is also possible in energy-saving mode.

If a charge status of the energy storage 320 drops below an additional, even lower threshold value, then the technology described herein can be deactivated. In this case, the mobile device 110 can only continue to be utilized when the energy storage 320 has been recharged or the mobile device 110 is connected to an external energy source.

### REFERENCE INDICATORS

100 System
105 Motor vehicle
110 Mobile device
120 Users
125 Control device
130 Processing equipment
135 Bluetooth interface
140 UWB interface
145 External control element
150 Interface
155 Internal control element
200 Procedure
205 Energy-saving mode with peripherals deactivated
210 Actuation of physical input element
215 Activate BLW scanning, establish connection
220 Request energy-saving mode
225 Actuation of external control element
230 Unlocking the vehicle
235 Detect actuation of internal operating element
240 Record actuation of HW element
245 UWB authentication, determine distance
250 Release immobilizer, start drive engine
305 Processing equipment
310 Touch-sensitive screen
315 Switches, push-button switches
320 Energy storage
325 Bluetooth interface
330 UWB interface

What is claimed is:

1. A method for controlling a motor vehicle by utilizing a mobile device, the method comprising:
detecting that a touch-sensitive screen of the mobile device is deactivated due to a low charge status of an energy storage device;
detecting an actuation of a physical switch of the mobile device;
establishing a Bluetooth connection with the motor vehicle; and
transmitting a request to unlock the motor vehicle via the Bluetooth connection.

2. The method according to claim 1, wherein a predetermined sequence of actuation of the switch is detected.

3. The method according to claim 1, wherein a predetermined sequence of actuation of a plurality of physical switches of the mobile device is detected.

4. The method according to claim 2, wherein a predetermined sequence of actuation of a plurality of physical switches of the mobile device is detected.

5. The method according to claim 1, wherein based on the Bluetooth connection, it is determined that the mobile device is located no further than a predetermined distance away from the motor vehicle.

6. The method according to claim 2, wherein based on the Bluetooth connection, it is determined that the mobile device is located no further than a predetermined distance away from the motor vehicle.

7. The method according to claim 1, wherein an actuation of a predetermined control element, which is accessible outside of the motor vehicle, is detected.

8. The method according to claim 2, wherein an actuation of a predetermined control element, which is accessible outside of the motor vehicle, is detected.

9. The method according to claim 1, wherein the motor vehicle is unlocked in response to the request.

10. The method according to claim 2, wherein the motor vehicle is unlocked in response to the request.

11. The method according to claim 1, wherein an actuation of a predetermined control element located in an interior of the motor vehicle is detected, a request for authentication is transmitted to the mobile device via the Bluetooth connection, and the mobile device initiates an authentication with the motor vehicle.

12. The method according to claim 2, wherein an actuation of a predetermined control element located in an interior of the motor vehicle is detected, a request for authentication is transmitted to the mobile device via the Bluetooth connection, and the mobile device initiates an authentication with the motor vehicle.

13. The method according to claim 11, wherein the authentication is based on a UWB connection.

14. The method according to claim 12, wherein the authentication is based on a UWB connection.

15. The method according to claim 11, wherein the authentication is based on a digital vehicle key which is stored on the mobile device.

16. The method according to claim 13, wherein the authentication is based on a digital vehicle key which is stored on the mobile device.

17. A control device for a motor vehicle, the control device comprising:
a Bluetooth interface; and
a processing device configured to:
establish a Bluetooth connection to a mobile device;
receive a request to unlock the motor vehicle via the Bluetooth connection;
detect an operation of a control element which is accessible on an exterior of the motor vehicle; and
unlock the motor vehicle.

18. A motor vehicle comprising a control device according to claim 17.

19. A mobile device comprising:
a touch-sensitive screen;
a physical switch;
an electrical energy storage unit;
a Bluetooth interface; and
a processing device configured to detect that the touch-sensitive screen is disabled due to a low status of charge of the energy storage device, to detect an actuation of the physical switch, to establish a Bluetooth connection with the motor vehicle, and to transmit a request to unlock the motor vehicle via the Bluetooth connection.
